(19) United States
(12) Patent Application Publication
(10) Pub. No.: US 2016/0239136 A1
(43) Pub. Date: Aug. 18, 2016

(54) INTEGRATED TOUCH AND FORCE DETECTION

(71) Applicant: Qualcomm Technologies, Inc., San Diego, CA (US)

(72) Inventors: Fatih Kocak, Alviso, CA (US); Melih Altun, San Jose, CA (US); Cetin Seren, Pleasanton, CA (US); Ali Ekici, Los Gatos, CA (US)

(21) Appl. No.: 15/042,058

(22) Filed: Feb. 11, 2016

Related U.S. Application Data
(60) Provisional application No. 62/115,261, filed on Feb. 12, 2015.

(51) Int. Cl. G06F 3/041; G06K 9/46; G06F 3/044

(52) U.S. Cl. CPC G06F 3/0414; G06F 3/0412; G06F 3/044; G06F 3/0416; G06K 9/46; G06K 2009/4666

(57) ABSTRACT

This disclosure provides systems, methods and apparatus for determining a force index associated with a touch event. One aspect of the subject matter described in this disclosure can be implemented in a touch sensor system. The touch sensor system can include a touchscreen including a plurality of electrodes, and a sense circuit operable to sense electrical signals from the plurality of electrodes. The touch sensor system also can include an image processing module operable to generate an image frame based on the electrical signals sensed by the sense circuit. The touch sensor system also can include a feature extraction module operable to analyze the image frame and to identify touch event candidates based on the analysis. The touch sensor system also can include a touch event detection module operable to determine, for each identified touch event candidate, whether the touch event candidate is associated with a touch event. The touch sensor system further includes a force detection module operable to determine, for each touch event candidate associated with a touch event, a first component of the image frame associated with an object effect. The force detection module is further operable to determine, for each touch event candidate associated with a touch event, a second component of the image frame associated with a force effect, and to determine a force index value associated with the force effect.

### PRIORITY DATA

This non-provisional application claims the benefit of priority under 35 U.S.C. 119(e) to U.S. provisional patent application No. 62/115,261 titled “SYSTEM AND METHOD FOR DETECTING PRESSURE APPLIED TO CAPACITIVE TOUCH PANELS” by Kocak et al. and filed on 12 Feb. 2015, which is hereby incorporated by reference herein in its entirety and for all purposes.

### TECHNICAL FIELD

This disclosure relates generally to user interface devices, and more particularly, to capacitive touch sensing devices for displays.

### BACKGROUND

Mobile devices such as smartphones, tablet computers, and other portable computing devices are ubiquitous in modern society. Many such devices include touch-sensitive displays, also referred to as touchscreen displays. Often a touchscreen is a primary mechanism of interaction of a user with the device. Touchscreens generally incorporate sensing systems capable of detecting touch events associated with the contact of an object, such as a finger or stylus, with the touchscreen. Many touchscreens include capacitive sensing systems such as mutual-capacitance-based sensing systems or self-capacitance-based sensing systems. For example, a mutual-capacitance-based sensing system generally includes a number of drive electrodes extending across a touch-sensitive region of the touchscreen display, as well as a number of sense electrodes extending across the touch-sensitive region over the drive electrodes.

During a scanning operation to determine whether a touch event has occurred, a drive circuit applies a drive signal to one or more of the drive electrodes and a sense circuit detects signals received from the sense electrodes. Because of capacitive coupling between each drive electrode and the overlying sense electrodes, a portion of the drive signal applied to a given drive electrode is capacitively-coupled onto the sense electrodes. The presence of an object on the touchscreen during the scanning operation changes the charge distributions around one or more intersections of the drive electrodes and sense electrodes proximate the object. The changes in the charge distributions affect the capacitive coupling of the drive signals onto corresponding sense electrodes. The resulting changes in the signals detected by the sense circuit can be processed and analyzed to determine that an object has contacted the touchscreen—an example of a “touch event”—as well as the location of the object.

### SUMMARY

The systems, methods and devices of this disclosure each have several aspects, no single one of which is solely responsible for the desirable attributes disclosed herein.

One aspect of the subject matter described in this disclosure can be implemented in a touch sensor system. The touch sensor system can include a touchscreen including a plurality of electrodes and a sense circuit operable to sense electrical signals from the plurality of electrodes. The touch sensor system also can include an image processing module operable to generate an image frame based on the electrical signals sensed by the sense circuit. The touch sensor system also can include a feature extraction module operable to analyze the image frame and to identify touch event candidates based on the analysis. The touch sensor system also can include a touch event detection module operable to determine, for each identified touch event candidate, whether the touch event candidate is associated with a touch event. The touch sensor system further includes a force detection module operable to determine, for each touch event candidate associated with a touch event, a first component of the image frame associated with an object effect. The force detection module is further operable to determine, for each touch event candidate associated with a touch event, a second component of the image frame associated with a force effect, and to determine a force index value associated with the force effect.

In some implementations, the touch event detection module is operable to, for each identified touch event candidate, identify an object type associated with the touch event candidate and to determine whether the touch event candidate is associated with a touch event based on the object type. In some implementations, the touch event detection module is operable to identify the object type based on one or both of a number of nodes contributing to the touch event candidate and a spatial distribution of the nodes contributing to the touch event candidate. In some other implementations, the touch event detection module is operable to identify the object type based on a curve-fitting algorithm.

In some implementations, the force detection module is operable to determine the first component of the image frame associated with the object effect based on one or more curve-fitting algorithms. In some implementations, the force detection module is operable to determine the second component of the image frame associated with the force effect by subtracting from the image frame the first component of the image frame associated with the object effect. In some implementations, the force detection module is operable to determine the force index value associated with the force effect based on one or both of an amplitude and a size associated with the force effect.

In some implementations, the touch sensor system further includes an event handling module operable to generate a data structure including an identification of a location of the touch event and the force index value. In some implementations, the event handling module is further operable to communicate the data structure to an application, the location of the touch event being a first input to the application, the force index value being a second input to the application.

In some implementations, the touchscreen is configured as a capacitance-based touchscreen, the plurality of electrodes including a plurality of drive electrodes and a plurality of sense electrodes. In some such implementations, the touch sensor system further includes a drive circuit operable to generate and apply drive signals to the plurality of drive electrodes. The sense circuit is operable to sense the electrical signals from the plurality of sense electrodes. In some such implementations, the touchscreen is more specifically configured as a mutual-capacitance-based touchscreen. In such implementations, the electrical signals sensed by the sense circuit are capacitively-coupled onto the plurality of sense electrode from the plurality of drive electrodes.

Another aspect of the subject matter described in this disclosure can be implemented in a display device that includes a display and a touch sensor system as described above.

Another aspect of the subject matter described in this disclosure can be implemented in a system capable of determining a force index value associated with a touch event. The system can include touch-sensitive means as well as means for sensing electrical signals from the touch-sensitive means. The system also can include means for generating an image frame based on the electrical signals sensed by the means for sensing. The system also can include means for analyzing the image frame and identifying touch event candidates based on the analysis. The system also can include means for determining, for each identified touch event candidate, whether the touch event candidate is associated with a touch event. The system further includes force detection means for determining, for each touch event candidate associated with a touch event, a first component of the image frame associated with an object effect. The force detection means also includes means for determining, for each touch event candidate associated with a touch event, a second component of the image frame associated with a force effect, and means for determining a force index value associated with the force effect.

In some implementations, the means for determining, for each identified touch event candidate, whether the touch event candidate is associated with a touch event includes means for identifying an object type associated with the touch event candidate, the determining of whether the touch event candidate is associated with a touch event being based on the object type. In some implementations, the means for determining which of the touch event candidates are associated with touch events includes means for identifying the object type based on one or both of: a number of nodes contributing to the touch event candidate and a spatial distribution of the nodes contributing to the touch event candidate. In some other implementations, the means for determining which of the touch event candidates are associated with touch events includes means for identifying the object type based on a curve-fitting algorithm.

In some implementations, the force detection means includes means for determining the first component of the image frame associated with the object effect based on one or more curve-fitting algorithms. In some implementations, the force detection means includes means for subtracting from the image frame the first component of the image frame associated with the object effect to determine the second component of the image frame associated with the force effect. In some implementations, the force detection means includes means for determining the force index value based on one or both of an amplitude and a size associated with the force effect.

In some implementations, the system further includes means for generating a data structure including an identification of a location of the touch event and the force index value. In some implementations, the system further includes means for communicating the data structure to an application, the location of the touch event being a first input to the application, the force index value being a second input to the application.

In some implementations, the touch-sensitive means includes a plurality of drive electrodes and a plurality of sense electrodes. In some such implementations, the system further includes means for generating drive signals and means for applying the drive signals to the drive electrodes. The means for sensing the electrical signals from the touch-sensitive means includes means for sensing the electrical signals from the plurality of sense electrodes.

Another aspect of the subject matter described in this disclosure can be implemented in a method for determining a force index associated with a touch event. The method can include sensing electrical signals from a touchscreen, and generating an image frame based on the sensed electrical signals. The method also can include analyzing the image frame and identifying touch event candidates based on the analysis. The method also can include determining, for each identified touch event candidate, whether the touch event candidate is associated with a touch event. The method further includes determining, for each touch event candidate associated with a touch event, a first component of the image frame associated with an object effect. The method further includes determining, for each touch event candidate associated with a touch event, a second component of the image frame associated with a force effect, and determining a force index value associated with the force effect.

In some implementations, the determining of whether the touch event candidate is associated with a touch event includes identifying an object type associated with the touch event candidate, the determining of whether the touch event candidate is associated with a touch event being based on the object type. In some implementations, the determining of which of the touch event candidates are associated with touch events includes identifying the object type based on one or both of: a number of nodes contributing to the touch event candidate and a spatial distribution of the nodes contributing to the touch event candidate. In some other implementations, the determining of which of the touch event candidates are associated with touch events includes identifying the object type based on a curve-fitting algorithm.

In some implementations, the determining of the first component of the image frame associated with the object effect is based on one or more curve-fitting algorithms. In some implementations, the determining of the second component of the image frame associated with the force effect includes subtracting from the image frame the first component of the image frame associated with the object effect. In some implementations, the determining of the force index value associated with the force effect is based on one or both of an amplitude and a size associated with the force effect.

In some implementations, the method further includes generating a data structure including an identification of a location of the touch event and the force index value. In some implementations, the method further includes communicating the data structure to an application, the location of the touch event being a first input to the application, the force index value being a second input to the application.

In some implementations, the touchscreen includes a plurality of drive electrodes and a plurality of sense electrodes. In some such implementations, the method further includes generating drive signals and applying the drive signals to the drive electrodes. The sensing of the electrical signals from the touchscreen includes sensing the electrical signals from the sense electrodes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a diagrammatic representation of an example display device according to some implementations.

FIG. 2 shows a diagrammatic representation of an example touch sensor system according to some implementations.

FIG. 3 shows a portion of an example drive circuit according to some implementations.

FIG. 4 shows a portion of an example sense circuit according to some implementations.

FIG. 5 shows a block diagram of example components of a display device according to some implementations.

FIG. 6 shows a diagrammatic cross-sectional side view of a portion of an example display device according to some implementations.

FIG. 7 shows a diagrammatic cross-sectional side view showing deformation of the portion of the example display device of FIG. 6 under the force of a finger.

FIG. 8 shows a block diagram of example modules of a display device according to some implementations.

FIG. 9 shows a flowchart of an example process for determining a force effect associated with a touch event according to some implementation.

FIGS. 10A and 10B show two-dimensional and three-dimensional plots, respectively, of a portion of an example image frame illustrative of an object effect as well as a force effect associated with a contact of an object on a touchscreen.

FIGS. 11A and 11B show two-dimensional and three-dimensional plots, respectively, of a portion of an example image frame illustrative of an isolation of the object effect contribution to the image frame of FIGS. 10A and 10B.

FIGS. 12A and 12B show two-dimensional and three-dimensional plots, respectively, of a portion of an example image frame illustrative of an isolation of the force effect contribution to the image frame of FIGS. 10A and 10B.

Like reference numbers and designations in the various drawings indicate like elements.

### DETAILED DESCRIPTION

The following description is directed to certain implementations for the purposes of describing various aspects of this disclosure. However, a person having ordinary skill in the art will recognize that the teachings herein can be applied in a multitude of different ways. Thus, the teachings are not intended to be limited to the implementations depicted solely in the Figures, but instead have wide applicability as will be readily apparent to one having ordinary skill in the art. Additionally, as used herein, the conjunction “or” is intended herein in the inclusive sense where appropriate unless otherwise indicated; that is, the phrase “A, B or C” is intended to include the possibilities of A; B; C; A and B; B and C; A and C; and A, B and C. Similarly, a phrase referring to “at least one of” a list of items refers to any combination of those items, including single members. As an example, “at least one of A, B, and C” is intended to cover the possibilities of A; B; C; A and B; B and C; A and C; and A, B and C.

This disclosure relates generally to devices, systems and methods for detecting and characterizing touch events, and more specifically, to devices, systems and methods for recognizing not only the occurrences of touch events but also the applications of force associated with detected touch events. Various implementations relate to systems, devices and methods for identifying effects associated with the contact of an object on a touchscreen, and more specifically, to systems, devices and methods for isolating effects associated with deformation of the touchscreen (hereinafter “force effects”) resulting from the force by which the object contacts the touchscreen from effects associated with the presence of the object on the touchscreen (hereinafter “object effects”). Some implementations utilize the capacitive touch sensing capabilities of a capacitance-based touchscreen to both detect touch events as well as to quantify the application of force associated with the touch events.

The force applied by an object can often be indicative of an intent, desire, emotion, mood or urgency of a user. For example, users typically apply different amounts of force when interacting with different applications and associated user interfaces. Previously, touch-sensitive user interface (UI) systems have been designed to exclude artifacts attributable to deformation; that is, to exclude contributions or components of sensed signals associated with force effects. In contrast, various implementations relate generally to detecting and characterizing such deformation, and more specifically, to quantifying the force producing the deformation. The quantified force can then be used as an additional input to the device, for example, to modify one or more actions or operations, to trigger one or more additional actions or operations, or to reduce false positives associated with incidental or accidental contacts with the touchscreen.

For example, the additional input based on the force effect can be used to augment or qualify the touch event input. As a more specific example, a display device can include a music application enabling a user to play a virtual keyboard or to strum a virtual guitar graphically rendered on a display. The location of the touch event can be used by the application as an input to determine which key or string was struck by the user while the second input based on the force effect can be used by the application to determine an amplitude of the resulting sound to be produced by a speaker within or connected to the display device. As another example, a display device can include a gaming application enabling a user to move and operate a virtual character or vehicle. In such a use case, a second input associated with a force effect can be used by the application to modify or adjust an action of the virtual character. As another example, an application can use a second input associated with a force effect to assign a priority or urgency to an action selected or triggered by a user using a touchscreen.

Mobile devices such as smartphones, tablet computers, and other portable computing devices are ubiquitous in modern society. Many such devices include touch-sensitive displays also referred to as touchscreen displays. Often the touchscreen is a primary mechanism of interaction of a user with the device. Touchscreens generally incorporate sensing systems capable of detecting touch events associated with the contact of an object, such as a finger or stylus, with the touchscreen. Many touchscreens include capacitance-based (or “capacitive”) sensing systems such as mutual-capacitance-based sensing systems or self-capacitance-based sensing systems. A mutual-capacitance-based sensing system generally includes a plurality of drive electrodes extending across a touch-sensitive region of the touchscreen, as well as a plurality of sense electrodes extending across the touch-sensitive region so as to cross over or under the drive electrodes. The drive electrodes are generally orthogonal to the sense electrodes, although this need not be the case. The crossings of the drive and sense electrodes result in a grid of non-physically-contacting intersections, each corresponding to a particular pair of one drive electrode and one sense electrode, and each associated with a particular position or region of the touchscreen. Each intersection may generally be referred to as a “node,” the location of which is pre-programmed or otherwise known by a touchscreen controller. Each node has an associated capacitance that is approximately or relatively static in the absence of other objects on or in close proximity to the node. In a mutual-capacitance-based sensing system, the static capacitance of each node results from a mutual capacitance between the respective pair of conductive drive and sense electrodes.

During a scanning operation to determine whether a touch event has occurred, a touchscreen controller applies a drive signal to (“drives”) each of one or more of the drive electrodes and detects an electrical signal from (“senses”) each of one or more of the sense electrodes. Because of capacitive coupling between each drive electrode and the overlying (or underlying) sense electrodes, a portion of the drive signal applied to each drive electrode is capacitively-coupled onto the overlying sense electrodes. The presence of an object on (or in close proximity over) the touchscreen during the scanning operation changes the charge distributions around one or more intersections of the drive electrodes and sense electrodes proximate the object. The changes in the charge distributions affect the capacitive coupling of the drive signals onto corresponding sense electrodes. Said differently, the presence of an object changes the electric field around the one or more intersections resulting in changes to the mutual capacitances between the drive electrodes and sense electrodes in the region of the object. The changes in the mutual capacitances affect the capacitive coupling of the corresponding drive signals onto the corresponding sense electrodes.

Characteristics (for example, voltage amplitude, frequency or phase) of the signals capacitively-coupled onto the sense electrodes and sensed by the sense circuit are subsequently processed and analyzed to determine the occurrences of touch events. For example, such touch events can be representative of contacts of one or more fingers with the touchscreen, the contact of a stylus or other input device with the touchscreen, or the proximity of one or more fingers, a stylus or other input device hovering over or approaching the touchscreen. Touch events also can include the reverse; that is, a touch event can be associated with the end of physical contact with the touchscreen (such as when a user removes a finger or stylus from the touchscreen or translates a finger or stylus across the surface from one position to another). In particular, changes in the characteristics of the sensed signals, such as the voltage amplitudes of the sensed signals, relative to a baseline or relative to previous or historical values can indicate the occurrences of such touch events. More specifically, a touchscreen controller or other processing device can receive data indicative of the sensed signals for each scanning operation (for example, in the form of an image frame) and apply various algorithms or perform various operations to determine whether the data in the image frame includes any anomalous values and whether such anomalous values indicate the occurrence of one or more touch events. Because the touchscreen controller or other processing device knows the locations of the intersections of the drive electrodes and sense electrodes, and because the touchscreen controller further knows which drive electrodes were driven in the scanning operation at which time and with which drive signals, the touchscreen controller also can determine the locations of the detected touch events.

Generally, a control system of a device that includes the touchscreen display is configured to trigger one or more actions or operations associated with an application executing in the device based on the detections and locations of touch events. To increase the abilities of users to interact with touchscreen devices, many touchscreen sensing systems are capable of recognizing multiple contacts simultaneously (also referred to as “multipoint touch events”) or recognizing more complex gestures associated with a user moving one or more fingers or other objects across a surface of the touchscreen according to a one or more of a variety of recognizable patterns. Although the capabilities to detect and recognize multipoint touch events and gestures have increased the variety of input mechanisms by which a user can interact with a device, it is desirable to develop and incorporate additional capabilities of interaction with devices.

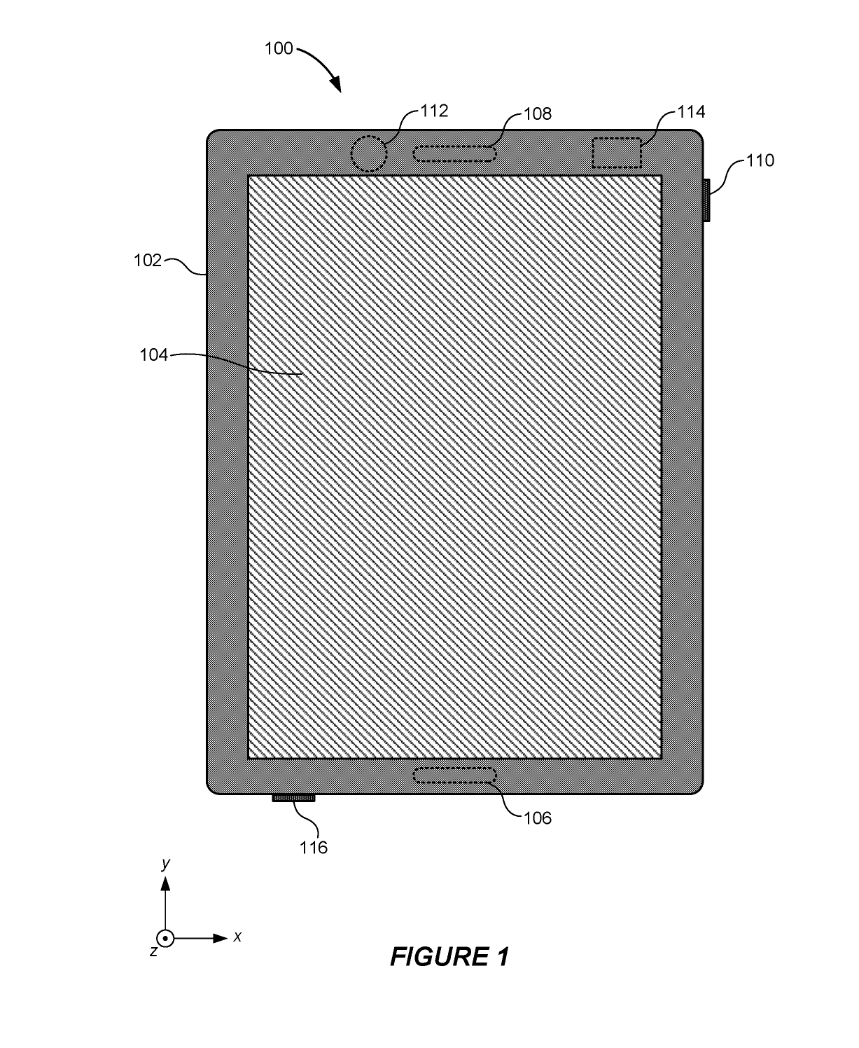

FIG. 1 shows a diagrammatic representation of an example display device 100 according to some implementations. The display device 100 can be representative of, for example, various mobile devices such as cellular phones, smartphones, multimedia devices, personal gaming devices, tablet computers, laptop computers, among other types of portable computing devices. However, various implementations described herein are not limited in application to portable computing devices. Indeed, various techniques and principles disclosed herein can be applied in traditionally non-portable devices and systems, such as in computer monitors, television displays, kiosks, vehicle navigation devices, and audio systems, among other applications. The display device 100 generally includes a housing (or “case”) 102 within which various circuits, sensors and other electrical components reside. The display device 100 also includes a touchscreen display (also referred to herein as a “touch-sensitive display”) 104. The touchscreen display 104 generally includes a display and a touchscreen arranged over or otherwise incorporated into or integrated with the display. In some implementations, the touchscreen is integrally formed with the display during manufacture of the display. In some other implementations, the touchscreen is a distinct device manufactured separately from the display and subsequently positioned over the display when assembling the display device 100.

The display can generally be any of a variety of display types using any of a variety of suitable display technologies. For example, the display can be a digital micro-shutter (DMS)-based display, a light-emitting diode (LED) display, an organic LED (OLED) display, a liquid crystal display (LCD), an LCD display that uses LEDs as backlights, a plasma display, an interferometric modulator (IMOD)-based display, or another type of display suitable for use in conjunction with touch-sensitive UI systems.

The display device 100 also can include various other devices or components for interacting with, or otherwise communicating information to or receiving information from, a user. For example, the display device 100 also can include one or more microphones 106, one or more speakers 108, and in some cases one or more physical buttons 110. The display device 100 also can include various other components enabling additional features such as, for example, one or more video or still-image cameras 112, one or more wireless network interfaces 114 (for example, Bluetooth, WiFi or cellular) and one or more non-wireless interfaces 116 (for example, a Universal Serial Bus (USB) interface or an HDMI interface).

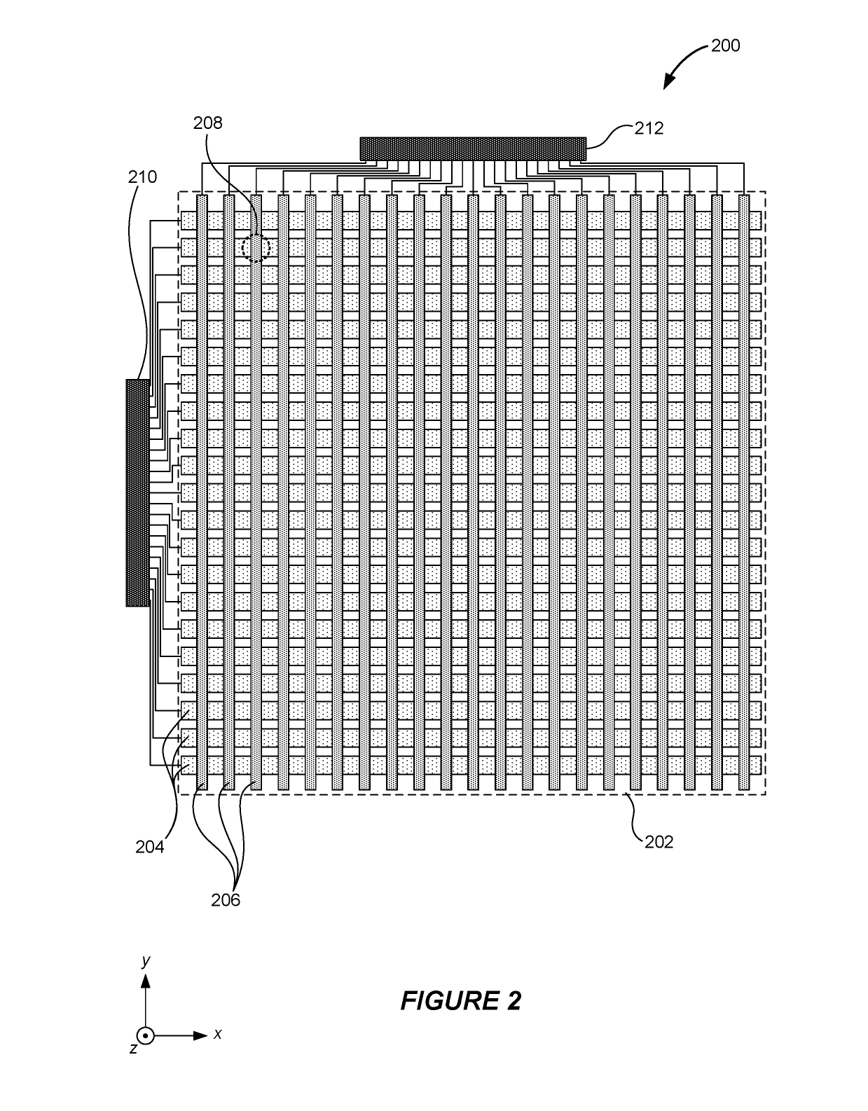

Generally, the touchscreen is but one part of a touch-sensitive user interface (UI) system (also referred to herein as a “touch sensor system”). FIG. 2 shows an example touch sensor system 200 according to some implementations. The touch sensor system 200 includes a touchscreen 202 that includes a plurality of first electrodes 204 extending in parallel across a touch-sensitive region of the touchscreen (for example, in the form of a plurality of parallel rows extending along an x-axis). The touchscreen 202 further includes a plurality of second electrodes 206 extending in parallel across the touch-sensitive region (for example, in the form of a plurality of parallel columns extending along a y-axis). Generally, the second electrodes 206 are orthogonal (or more simply perpendicular) to the first electrodes 204 so as to cross over the first electrodes. In various implementations, the touchscreen 202, and more generally the touch sensor system 200, is a capacitance-based sensing system. In some implementations, the touch sensor system 200 is more particularly configured as a mutual-capacitance-based sensing system. However, in some other implementations, the techniques and principles described herein can be applied to self-capacitance-based sensing systems. As such, while the following description may generally focus on implementations for use in mutual-capacitance-based sensing systems, a person having ordinary skill in the art will recognize that various techniques and principles disclosed herein are applicable to other capacitance-based sensing systems as well.

In implementations in which the touchscreen 202 is configured as a mutual-capacitance-based sensing system, the first electrodes 204 can be configured as drive (or “transmitter”) electrodes (and are hereinafter also referred to as “drive electrodes 204”). In such implementations, the second electrodes 206 can be configured as sense (or “receiver”) electrodes (and are hereinafter also referred to as “sense electrodes 206”). In such implementations, the crossing relationship of the drive electrodes 204 and the sense electrodes 206 results in a grid of non-physically-contacting intersections or “nodes” 208, each of which corresponds to a particular pair of one drive electrode 204 and one sense electrode 206. Each node 208 is associated with a particular position or region of the touchscreen 202 corresponding to the respective intersection, the location of which is pre-programmed or otherwise known by a touchscreen controller. Each node 208 has an associated capacitance that is approximately or relatively static in the absence of external objects on or in close proximity to the node. In a mutual-capacitance-based sensing system, the static capacitance of each node 208 results from a mutual capacitance between the respective pair of one drive electrode 204 and one sense electrode 206.

The touch sensor system 200 includes at least one drive (or “transmitter”) circuit 210 for generating and applying excitation (or “drive”) signals to drive the drive electrodes 204 during each scanning operation. In some implementations, the drive circuit 210 generates and applies the drive signals in the form of alternating current (AC) signals, for example, AC voltage signals having various amplitude, frequency and phase characteristics. The touch sensor system 200 also includes at least one sense (or “receiver”) circuit 212 for receiving and sensing (also referred to herein as “detecting,” “measuring,” “capturing” or “determining”) values of electrical signals (for example, AC voltage signals) capacitively-coupled onto the sense electrodes 206 as a result of the mutual capacitances between the drive electrodes 204 and the sense electrodes 206.

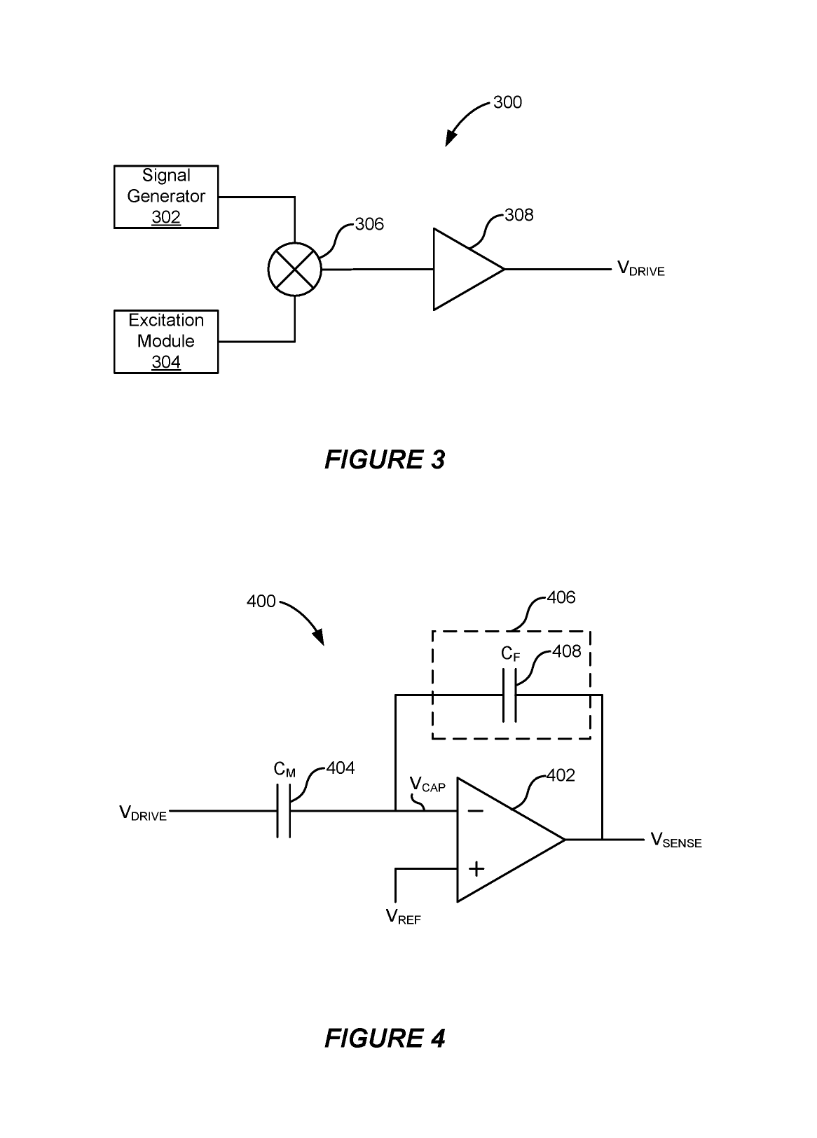

FIG. 3 shows a portion of an example drive circuit 300 according to some implementations. For example, the drive circuit 210 of FIG. 2 can include the drive circuit 300 of FIG. 3. The drive circuit 300 generally includes a signal generation circuit (“signal generator”) 302 configured to generate a periodic oscillating electrical signal, for example, a sinusoidal AC voltage signal V_{GEN} having a frequency f and an amplitude A. The drive circuit 300 further includes an excitation circuit (or “excitation module”) 304 configured to generate or store an excitation matrix that determines which drive electrodes are driven during a given frame, or sub-frame within a frame, of a scanning operation. For example, the drive circuit 300 further includes at least one mixing circuit (mixer) 306, including one or more of a multiplication circuit (multiplier), a modulation circuit (modulator) and a multiplexing circuit (multiplexer), that combines (for example, multiplies, modulates or multiplexes) the AC voltage signal output from the signal generator 302 with values of the excitation matrix output by the excitation module 304 to generate a plurality of drive signals V_{DRIVE} for all or a subset of the drive electrodes. The values of the matrix elements of the excitation matrix dictate the values of various signal characteristics (for example, amplitude or phase) of the resultant drive signals. In the illustrated implementation, the output of the mixer 306—the drive signal V_{DRIVE}—is then passed to a buffer 308 and subsequently to one or more of the drive electrodes. As persons of ordinary skill in the art will understand, although only one buffer 308 is shown outputting one drive signal V_{DRIVE}, the drive circuit 300 can include a buffer for each of the drive electrodes or for each of a number of sets of drive electrodes. Indeed, the drive circuit 300 can include an equivalent number of mixers 306 as well, and in some cases, multiple signal generators or multiple excitation modules as well.

FIG. 4 shows a portion of an example sense circuit 400 according to some implementations. For example, the sense circuit 212 of FIG. 2 can include the sense circuit 400 of FIG. 4. The sense circuit 400 generally includes an amplification circuit (amplifier) 402, such as an operational amplifier (OpAmp), having two inputs and one output. In the illustrated implementation, a first of the inputs (for example, the non-inverting or “positive” terminal) is electrically coupled with a reference voltage source (for example, an electrical ground) having a reference voltage V_{REF}. The second of the inputs (for example, the inverting or “negative” terminal) is electrically coupled with a sense electrode to receive a voltage signal V_{CAP} coupled onto the sense electrode from one or more underlying drive electrodes. The capacitive element 404 is not a capacitor component; rather, the capacitive element 404 represents a mutual capacitance C_{M} between the sense electrode and an underlying drive electrode (or in the case of a self-capacitance-based sensing system, the self-capacitance between the sense electrode and an underlying ground electrode or ground plane). The sense circuit 400 further includes a feedback circuit 406 electrically connected in parallel with the amplifier 402 between the inverting terminal of the amplifier and the output terminal. In some implementations, the feedback circuit 406 includes a feedback capacitor 408 having a feedback capacitance C_{F}. In some implementations, the feedback circuit 406 also can include a feedback resistor or various arrangements of capacitors, resistors or other circuit components.

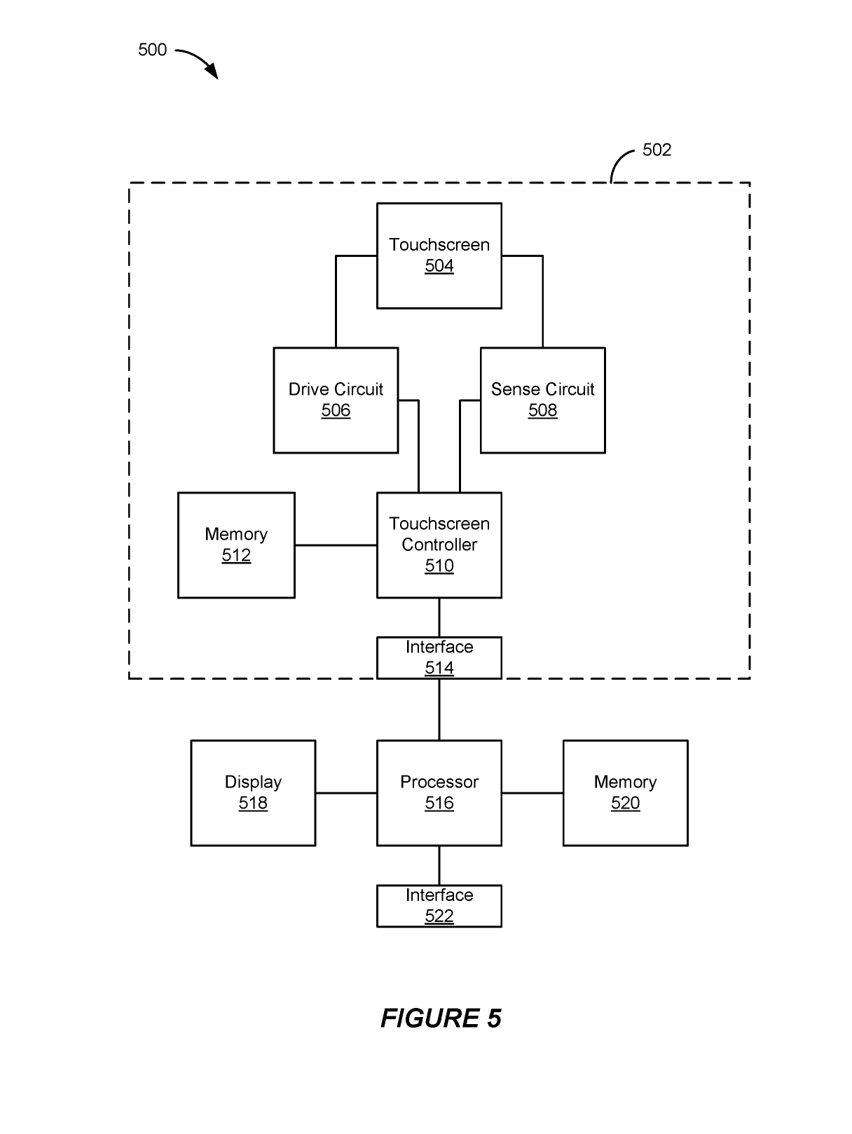

FIG. 5 shows a block diagram of example components of a display device 500 according to some implementations. As shown, the display device 500 includes a touch sensor system 502 such as or similar to the touch sensor system 200 described with reference to FIG. 2. As similarly described above, the touch sensor system 502 includes a touchscreen 504, a drive circuit 506 and a sense circuit 508. The touch sensor system 502 further includes a touchscreen control system (also referred to herein as a “touchscreen controller”) 510 that controls the drive circuit 506 and the sense circuit 508.

The touchscreen controller 510 can send instructions to (or otherwise control or cause) the drive circuit 506 to generate and apply one or more drive signals to each of one or more of the drive electrodes of the touchscreen 504 during each scanning operation. The instructions can control various characteristics of the drive signals to be generated by the drive circuit (for example, such as amplitude, frequency and phase). The touchscreen controller 510 also can send instructions to (or otherwise control or cause) the sense circuit 508 to enable or otherwise control various sensing circuitry components within the sense circuit (such as OpAmps, integrators, mixers, analog-to-digital converters (ADCs) or other signal recovery and data capture circuits) to sense, capture, recover, demodulate or latch values of the sensed signals during each scanning operation.

In the illustrated implementation, the drive circuit 506 and the sense circuit 508 are diagrammatically shown as separate blocks. For example, each of the drive circuit 506 and the sense circuit 508 can be physically implemented in a separate respective circuit, such as a distinct integrated circuit (IC) chip. In some other implementations, the drive circuit 506 and the sense circuit 508 can both be physically implemented within a single IC chip or system-on-chip (SoC). Additionally, in some implementations, the touchscreen controller 510 can itself include both the drive circuit 506 and the sense circuit 508 within a single IC chip or SoC. The touchscreen controller 510 also generally includes a processing unit (“or processor”).

While the touchscreen controller 510 is shown and referred to as a single device or component, in some implementations, the touchscreen controller 510 can collectively refer to two or more different IC chips or multiple discrete components. For example, in some implementations the touchscreen controller 510 can include two or more processors each implemented with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The touchscreen controller 510 also can include an internal memory device such as, for example, a volatile memory array such as a type of random access memory (RAM). Such a fast access memory can be used by the touchscreen controller 510 to temporarily store drive instructions or drive data for use in generating drive signals or otherwise controlling the drive circuit 506, sense instructions for use in controlling the sense circuit 508, or sensed signal data representative of raw signal data received from the sense circuit 508 (or processed data derived from raw signal data received from the sense circuit 508).

In some implementations, the touch sensor system 502 can include a memory 512 in addition to or in lieu of the internal memory within the touchscreen controller 510. The memory 512 can include or collectively refer to one or more memory devices or components. In some implementations, one or more of the memory components can be implemented as a NOR- or NAND-based Flash memory array. In some other implementations, one or more of the memory components can be implemented as a different type of non-volatile memory. And as described above, the memory 512 also can include volatile memory such as RAM including dynamic RAM (DRAM). In addition to the data or instructions that can be temporarily stored in the internal memory, the memory 512 also can store processor-executable (or “computer-executable”) code (or “instructions” or “software”) that when executed by the touchscreen controller 510, is configured to cause various operations to be performed by the touchscreen controller such as, for example, communicating instructions to the drive circuit 506 or the sense circuit 508 (including requesting data from the drive circuit or the sense circuit) as well as performing various signal or image processing operations on sensor data received from the sense circuit.

In some implementations, the memory 512 also can store processor-executable code that when executed by the touchscreen controller 510 is configured to cause the touchscreen controller to perform touch event and force event detection operations. In some implementations, the touchscreen controller 510 also can be configured as a controller for other components of the display device 500, for example, the touchscreen controller can include a display driver for controlling a display 518. In some implementations, the touchscreen controller 510 can be the master controller of the entire display device 500 controlling any and all electrical components within the display device 500. In such implementations, the touchscreen controller 510 can execute an operating system stored in the memory 512.

In some other implementations, the touchscreen controller 510 can be in communication with a separate processor 516, for example, a central processing unit (CPU), via a communication interface 514 (for example, a SATA Express bus such as a PCI Express bus). In some such implementations, the processor 516 controls the touchscreen controller 510 as well as other components of the display device 500 including the display 518. For example, the processor 516 can execute an operating system stored as processor-executable code in a memory 520 (for example, a solid-state drive based on NAND- or NOR-based flash memory). The processor 516 also can be connected to one or more wireless network or wired communication interfaces 522 enabling communication with other devices over a wireless network or via various wired cables.

A power supply (not shown) can provide power to some or all of the components in the display device 500. The power supply can include one or more of a variety of energy storage devices. For example, the power supply can include a rechargeable battery, such as a nickel-cadmium battery or a lithium-ion battery. In implementations incorporating a rechargeable battery, the rechargeable battery may be chargeable using power coming from, for example, a wall socket or a photovoltaic (“solar”) device or array. Additionally or alternatively, the rechargeable battery can be wirelessly chargeable.

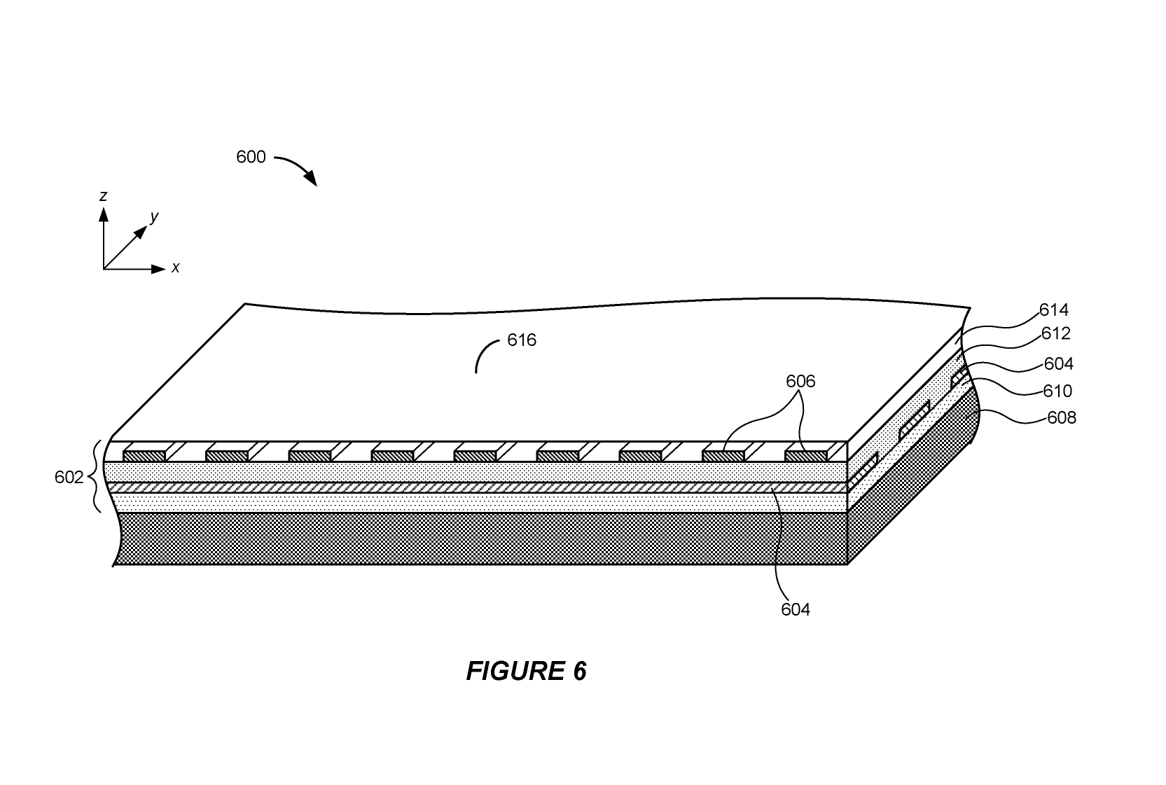

FIG. 6 shows a diagrammatic cross-sectional side view of a portion of an example display device 600 according to some implementations. For example, the display device 600 can represent physical implementations (not to scale) of the display devices and touch sensor systems described above. In the illustrated example implementation, a touchscreen 602 is arranged over a display 608. As described above, for example, with reference to the touch sensor system 200 of FIG. 2, the touchscreen 602 includes a number of drive electrodes 604 and overlying sense electrodes 606. The touchscreen 602 can generally include any suitable number and arrangement of layers. For example, the touchscreen 602 can include a number of individual layers each formed over one another in a stacked arrangement. As another example, the touchscreen 602 can include one or more laminate structures, each of which can include one or more layers laminated together. The touchscreen 602 also can include one or more substrates upon which one or more individual layers or laminate structures can be formed, positioned, laminated, bonded or otherwise assembled. As described above, in some implementations, the touchscreen 602 is integrally formed with the display 608 during manufacture of the display. In some other implementations, the touchscreen 602 is a distinct device (or assembly) manufactured separately from the display 608 and subsequently positioned on or over the display when assembling the display device 600.

In some implementations, the touchscreen 602 includes a first layer 610 on or over which the drive electrodes 604 are deposited, formed or otherwise arranged. In some implementations, the first layer 610 is or includes a rigid or semi-rigid transparent substrate. The first layer 610 can be formed of any suitable dielectric material such as one or more of a variety of glass materials or plastic materials. The drive electrodes 604 also are generally transparent, for example, formed of one or more transparent metallic or otherwise conductive oxide materials such as indium tin oxide (ITO). The touchscreen 602 also can include a second layer 612 on or over which the sense electrodes 606 are deposited, formed or otherwise arranged. For example, the second layer 612 can be formed of one or more flexible or deformable materials such as various plastic materials. In some implementations, the second layer 612 can itself be a multilayer or laminate structure including two or more layers at least one of which is deformable and at least one of which is flexible. The sense electrodes 606 also are generally transparent, for example, formed of one or more transparent metallic or otherwise conductive oxide materials such as indium tin oxide (ITO). As shown, the touchscreen 602 also can include a protective cover layer 614 having an upper (or outer) surface 616. For example, the cover layer 614 also can be formed of one or more flexible or deformable materials such as various plastic materials. Again, the particular number and arrangement of layers of the touchscreen 602 can vary, as can the selection of materials and thicknesses of the respective layers.

However, in various implementations, the touchscreen 602 is formed or otherwise assembled such that, responsive to suitable force (or similarly pressure) by a finger, stylus or other object a user uses to interact with the touchscreen, the touchscreen is strained or otherwise deformed resulting in a change in the geometrical arrangement between ones of the drive electrodes 604 and sense electrodes 606 in the region of the object. For example, the touchscreen 602 can be deformed under sufficient force as applied by a finger to cause one or more of the drive electrodes 604 to move towards one or more of the sense electrodes 606 along a z-axis perpendicular to the plane of the touchscreen resulting in a decrease in the distance (or separation) between the drive and sense electrodes along the z-axis. Such a decrease in separation can result in a change (for example, an increase) in the mutual capacitance between one or more pairs of drive and sense electrodes (or an increase in the self-capacitance between sense electrodes and an underlying ground electrode in a self-capacitance-based sensing system). The incorporation of a rigid substrate as the first layer 610 can, in some implementations, prevent or at least limit movement of the drive electrodes 604 while other overlying portions of the touchscreen 602 are deformed ensuring that the separation of the drive electrodes 604 and the sense electrodes 606 in the region of the deformation will decrease.

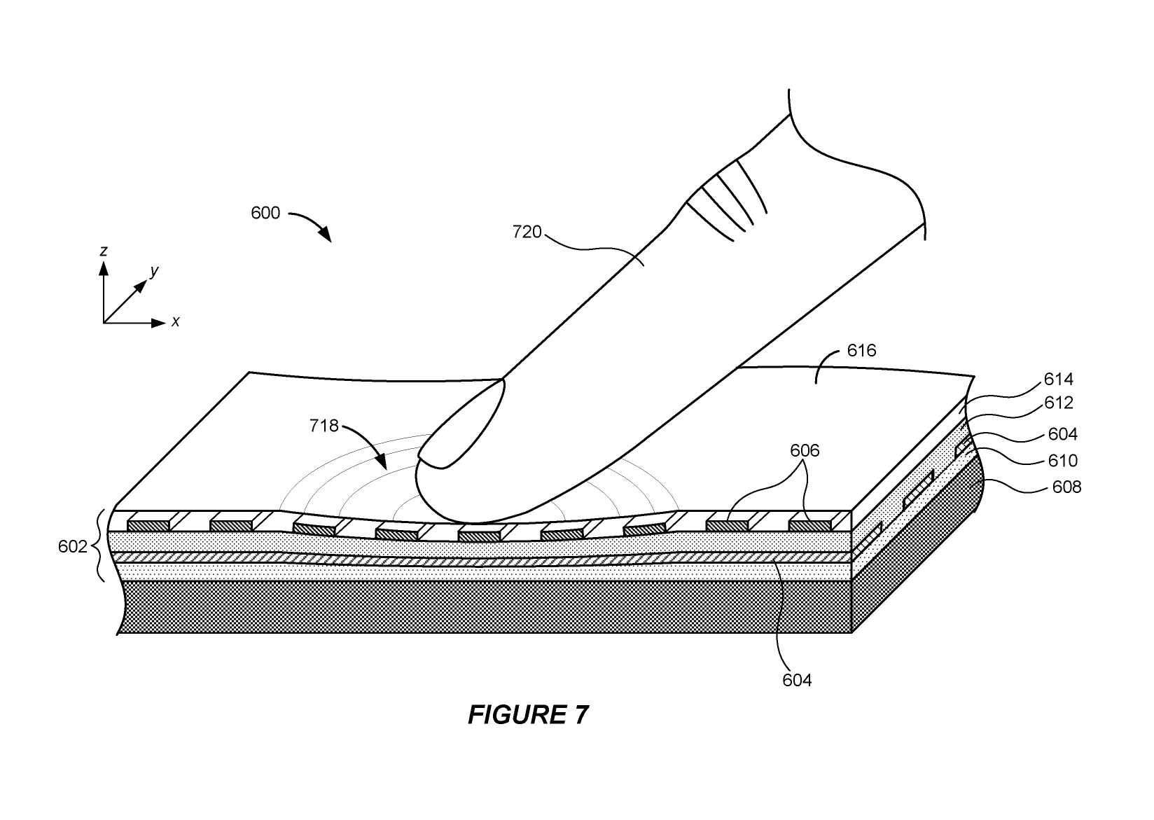

FIG. 7 shows a diagrammatic cross-sectional side view showing deformation of the portion of the example display device 600 of FIG. 6 under the force of a finger. As shown, when a user contacts the surface 616 of the touchscreen 602 with a finger 720, the region 718 of the touchscreen under and around the area of contact can be temporarily strained or otherwise deformed. The extent of the deformation, and especially the strain along the z-axis, is dependent on the force applied by the finger 720 (or other object). As described above, such deformation can cause one or more of the sense electrodes 606 to move closer in proximity to one or more of the drive electrodes 604. Because the capacitance between a given pair of one drive electrode and one sense electrode is dependent on the distance between them, and more generally the geometrical relationship of the pair, the mutual capacitance of each respective node in the region 718 of the deformation changes based on the amount of deformation. Such changes in capacitance caused by the deformation result in recognizable artifacts in the signals sensed by the sense circuit and provided to the touchscreen controller.

Various implementations relate to systems, devices and methods for identifying effects associated with the contact of an object on a touchscreen, and more specifically, to systems, devices and methods for isolating effects associated with deformation of the touchscreen (“force effects”) resulting from the force by which the object contacts the touchscreen from effects associated with the presence of the object on the touchscreen (“object effects”). As initially described above, the magnitude and other characteristics of the deformation, the change in capacitance directly attributable to the deformation, and consequently the contribution to the sensed signals due to the force effects, generally depend on the magnitude of the force applied and in some cases also the size and shape of the area within which the force is applied. The size and shape of the area within which the force is applied is generally indicative of the type of object or objects in contact with the touchscreen. Examples of object types can include adult fingers, child fingers, finger nails, knuckles, palms, pens and styluses, among other possibilities including other anatomical objects or inanimate objects.

The force applied by an object can often be indicative of an intent, desire, emotion, mood or urgency of a user. For example, users typically apply different amounts of force when interacting with different applications and associated user interfaces. Previously, touch-sensitive UI systems have been designed to exclude artifacts attributable to deformation; that is, to exclude contributions or components of sensed signals associated with force effects. In contrast, various implementations relate generally to detecting and characterizing such deformation, and more specifically, to quantifying the force producing the deformation. The quantified force can then be used as an additional input to the device, for example, to modify one or more actions or operations, to trigger one or more additional actions or operations, or to reduce false positives associated with incidental or accidental contacts with the touchscreen.

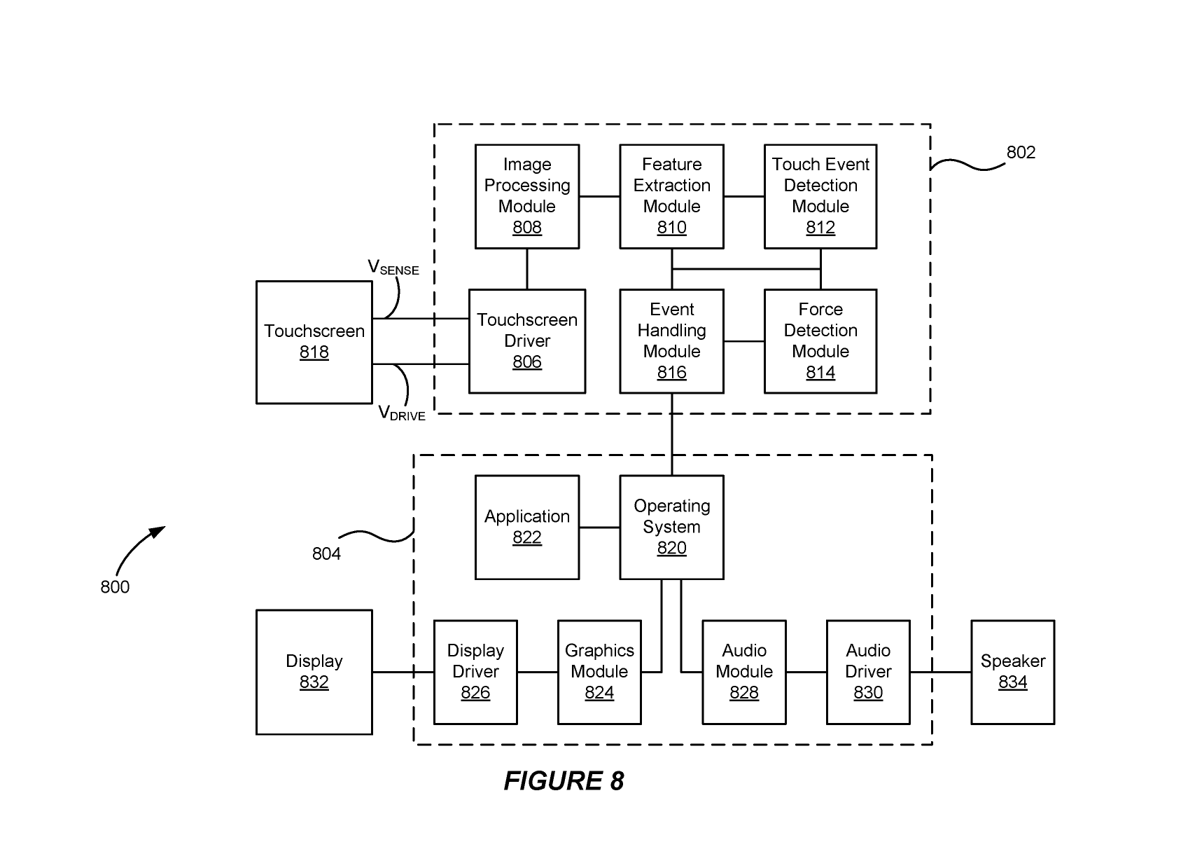

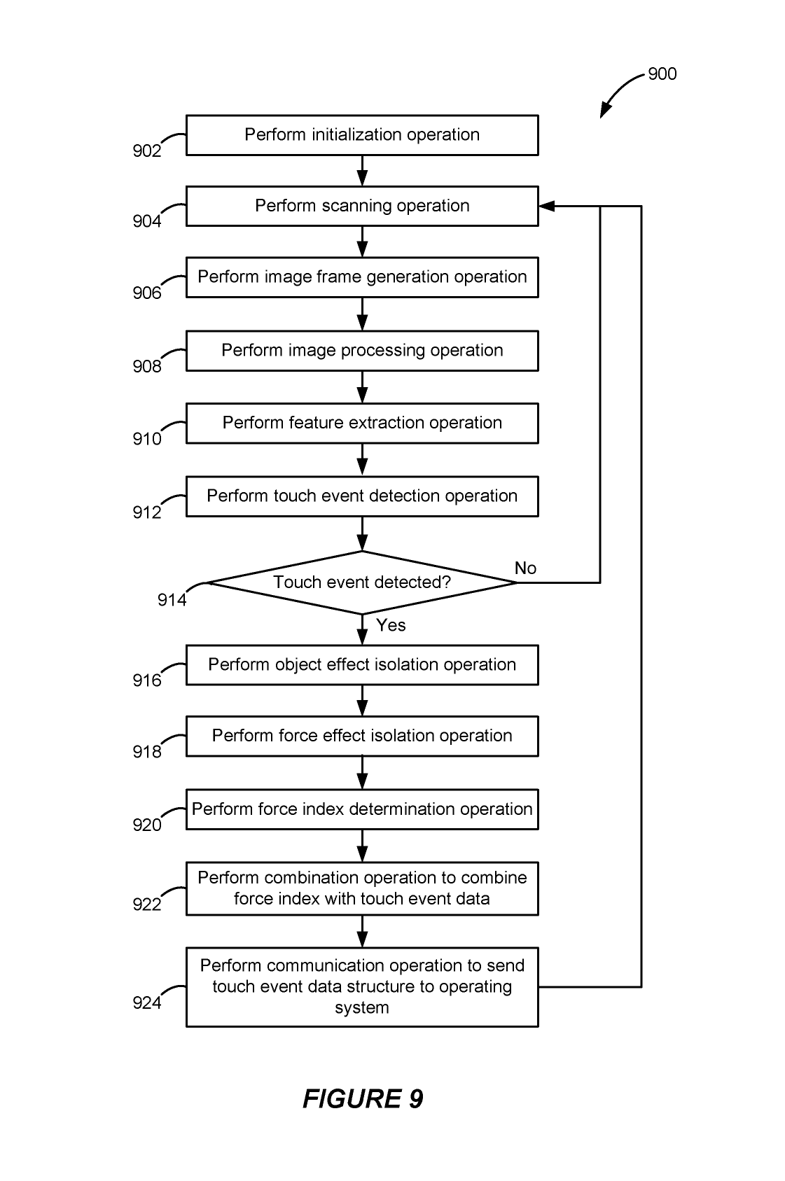

FIG. 8 shows a block diagram of example modules of a display device 800 according to some implementations. FIG. 9 shows a flowchart of an example process 900 for determining a force effect associated with a touch event according to some implementation. For example, the display device 800 shows various modules that can be implemented by the display device 500 of FIG. 5 to perform various operations described with reference to the process 900 of FIG. 9.

The modules of the display device 800 are shown grouped into a touchscreen control system (“touchscreen controller”) 802 and a device system 804. However, as described above, in some implementations one or more of the modules of the touchscreen controller 802 and device system 804 can be implemented within the same processors or other hardware, firmware and software components as well as combinations of such components within the display device 800. Additionally, one or more of the modules described with reference to FIG. 8 can be combined in some implementations. Conversely, one or more of the modules described with reference to FIG. 8 can be separated into two or more modules in some implementations. Furthermore, some operations described as being performed by particular ones of the modules of FIG. 8 can be performed by other ones of the modules in some other implementations. As such, the number, groupings and arrangements of the modules shown and described with reference to FIG. 8 should not be construed as limiting in all implementations; rather, the modules shown and described with reference to FIG. 8 (and FIG. 9) are representative of some example constructs, for example, to aid in understanding the disclosure and may be modified without departing from the scope of this disclosure.

As shown, the touchscreen controller 802 generally includes a touchscreen drive module (“touchscreen driver”) 806 capable of sending drive data to a touchscreen 818 and receiving sensor data from the touchscreen 818. In some implementations, the touchscreen 818 includes a drive circuit and a sense circuit (such as the drive circuit 210/506 and the sense circuit 212/508 described above). In some other implementations, the drive and sense circuits are included within the touchscreen controller 802. The touchscreen controller 802 further includes an image processing module 808, a feature extraction module 810, a touch event detection module 812, a force detection module 814 and an event handling module 816 configured to send and receive information to and from the device system 804 including touch event data and associated force event data. In some implementations, each of the modules described with reference to the touchscreen controller 802 of FIG. 8 can be implemented as software executing on any suitable combination of hardware (some of which may be shared with the device system 804 described below).

The device system 804 generally includes an operating system 820 (for example, executing on a CPU), an application 822 executing in conjunction with the operating system, a graphics module 824 capable of generating graphics data based on the application, a display driver 826 configured to communicate the graphics data to a display 828 for display to a user, an audio module 830 capable of generating audio data based on the application, and an audio driver 832 configured to communicate the audio data to a speaker 834. In various implementations, each of the modules described with reference to the device system 804 of FIG. 8 can be implemented as software executing on any suitable combination of hardware.

In some implementations, the process 900 begins in block 902 with performing an initialization operation. For example, the initialization operation can generally include initializing the touch modules within the touchscreen controller 802. As a more specific example, initializing the touch modules can include initializing various variables and functions implemented as software. The initialization operation also can include initializing the touchscreen driver 806, which controls the interaction of the touch controller and the touchscreen 818.

The process 900 proceeds in block 904 with performing a scanning operation. Generally, the scanning operation includes both a driving operation in which drive signals are generated and applied to the drive electrodes (for example, by the drive circuit 210/506), as well as a sensing operation during which the sense electrodes are sensed (for example, by the sense circuit 212/508) to obtain sensed voltages V_{SENSE}. The sensing components of the sense circuit are typically enabled at about the same time as, or within a very short time duration after, the drive signals are applied to the drive electrodes to enable the sense circuit to sense the coupled signals before they decay appreciably. The drive and sensing schemes can generally depend on a number of factors including, for example, the size of the touchscreen, the number of drive electrodes, the accuracy or resolution desired, power consumption constraints and whether multi-touch detection is enabled. In some implementations, the drive electrodes are driven sequentially (for example, row by row) while in other implementations, the drive electrodes can be driven in groups where each drive electrode of a group is driven in parallel and where the groups are driven sequentially (for example, odd rows then even rows, or in multiple sets of non-adjacent rows). In still other implementations, one or more adjacent ones of the drive signals can be driven with orthogonal drive signals. For example, a first drive electrode can be driven with a first drive signal having a first amplitude, a first frequency and a first phase, while an adjacent second drive electrode can be driven with a second drive signal having the first amplitude, the first frequency and a second phase shifted by an integer multiple of 90 degrees relative to the first phase. Generally, orthogonal signals are signals whose components can be separated out from one another at a receiver (such as in the sense circuit).

The process 900 proceeds in block 906 with performing an image frame generation operation. For example, in some implementations the sense circuit 508 is configured to generate the image frame in the form of a matrix of values based on the sensor data obtained by the sense circuit during the scanning operation. For example, each of the matrix values can include the coordinates of a respective one of the nodes (for example, an x-axis coordinate and ay-axis coordinate) as well as a value representative of an amplitude of the sensed voltage signal V_{SENSE} obtained for the node (or a value based on the amplitude of the sensed voltage signal V_{SENSE}). For example, the value associated with the node can more specifically represent an amplitude relative to a baseline amplitude. In some other implementations, the touchscreen controller 802 can generate the image frame based on raw or minimally processed sensor data obtained from the sense circuit. For example, the image processing module 808 can generate the image frame.

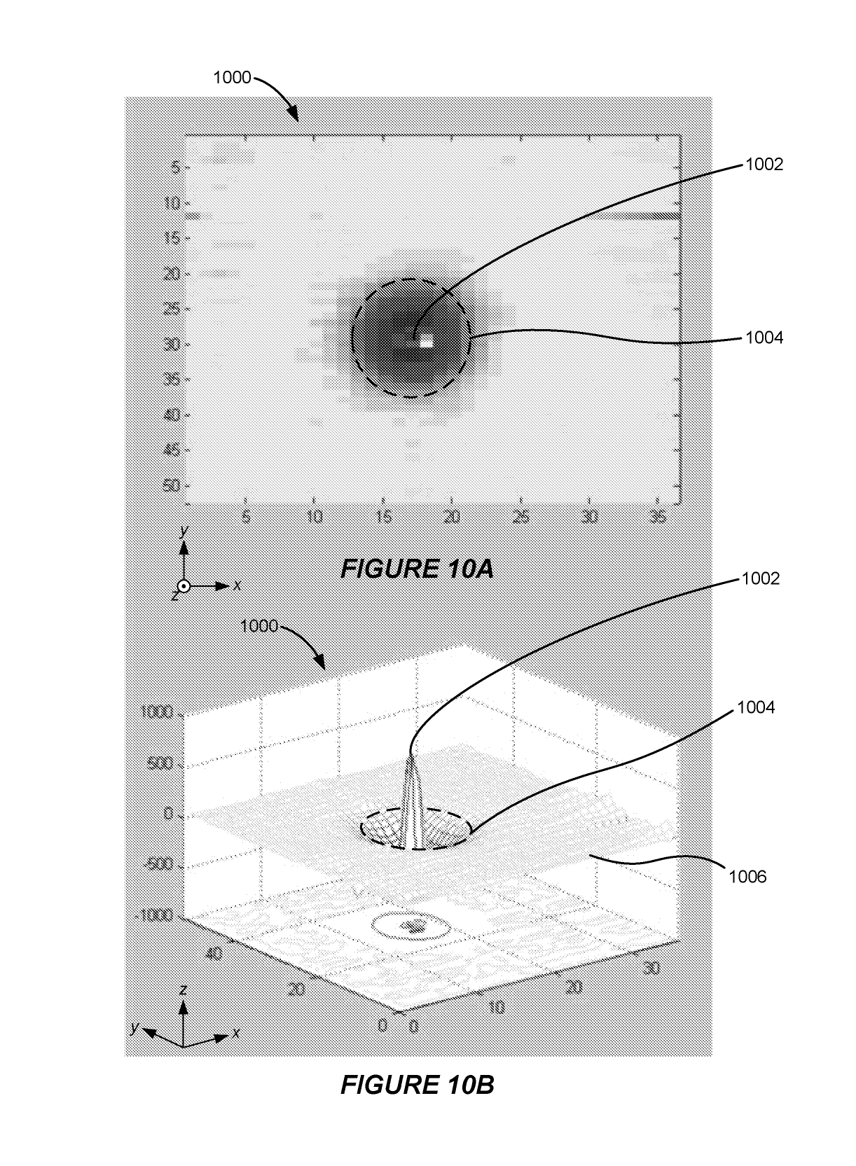

FIGS. 10A and 10B show two-dimensional and three-dimensional plots, respectively, of a portion of an example image frame 1000 illustrative of both an object effect as well as a force effect associated with a contact of an object on a touchscreen. More particularly, the image frame 1000 includes a peak 1002 resulting from an object effect associated with the change in the mutual capacitance caused to one or more nodes as a result of the presence of a conductive object on or over the touchscreen. The image frame 1000 further includes a depression 1004 (the approximate boundary of which is outlined with a dashed reference circle) resulting from a force effect associated with the deformation of the region of the touchscreen in proximity to the contact. In some implementations, the presence of an object tends to change the capacitance values of nearby nodes to increase the amplitudes of the sensed signals while greater deformation tends to change the capacitance values of the nodes to decrease the amplitudes of the sensed signals, as shown in FIGS. 10A and 10B.

In some other implementations, the presence of an object can change the capacitance values of nearby nodes to decrease the amplitudes of the sensed signals while greater deformation can change the capacitance values of the nodes to increase the amplitudes of the sensed signals. Generally, in some configurations, object effects can tend to provide contributions to the sensed signals in a first direction while force effects tend to provide contributions to the sensed signals in a second direction opposite that of the first direction. As such, although FIGS. 10A and 10B show the peak 1002 as having a positive value relative to a baseline 1006 and the deformation 1004 as having a negative value relative to the baseline, this is for illustrative purposes only (for example, the deformation can be manifested as a hill while the presence of the object can be manifested as a steep hole within the hill). Additionally, in some other implementations, the presence of an object also can change the capacitance values of nearby nodes in the same direction as the deformation (for example, both can increase the capacitance values or both can decrease the capacitance values), and thus, both object and force effects can change the amplitudes of the sensed signals in the same direction (for example, both can decrease the amplitudes of the sensed signals or both can increase the amplitudes of the sensed signals).

The process 900 proceeds in block 908 with performing an image processing operation on the image frame generated in block 906. For example, in some implementations the image processing module 808 is configured to perform the image processing operation. The image processing operation can generally include one or more of various operations (also referred to as “algorithms”) such as, for example, digital filtering operations or other noise removal operations to remove noise from or otherwise clean the image. For example, such noise can originate from other electrical components, external radiation, a noisy charger, or water on the touchscreen. In instances in which water is present on the touchscreen, the image processing operation performed in block 908 can include the execution of a water normalization algorithm.

The process 900 proceeds in block 910 with performing a feature extraction operation on the processed image frame. For example, in some implementations the feature extraction module 810 performs the feature extraction operation. In some implementations, the feature extraction operation is broadly designed to identify capacitive signatures of image features (hereinafter referred to as “touch event candidates”) that might be indicative of objects in contact with the touchscreen 818. In some implementations, the feature extraction operation includes identifying touch event candidates by analyzing peaks in the image frame. For example, the feature extraction module 810 can identify touch event candidates based on the areas under peaks (for example, in numbers of nodes or in actual estimated area), the amplitudes of peaks (for example, by comparing the amplitude to a threshold), the sharpness of peaks (for example, by comparing the slope of a peak to a threshold), or by combinations of such techniques. Additionally or alternatively, the feature extraction module 810 can identify touch event candidates based on one or more centroid identification methods or techniques. Additionally or alternatively, the feature extraction module 810 can identify touch event candidates based on one or more curve-fitting methods or techniques. In some implementations, the feature extraction operation also generally includes identifying the location of each of the touch event candidates as well as the size, shape or area associated with the touch event candidate. In some implementations, the location associated with a touch event candidate is identified as the x- and y-coordinates associated with one of the nodes determined to be nearest a center of a centroid.

The process 900 proceeds in block 912 with performing a touch event detection operation based on the touch event candidates identified in the feature extraction operation. For example, in some implementations the touch event detection module 812 performs the touch event detection operation. In some implementations, the touch event detection operation broadly includes analyzing the touch event candidates identified in the feature extraction operation and determining whether any of the touch event candidates are representative of an actual intended touch event. In some implementations, the touch event detection operation includes an object identification operation. For example, the touch event detection module 812 can identify an object type (if any) associated with each of the touch event candidates based on a number of nodes contributing to the feature, a spatial distribution of the nodes contributing to the feature, as well as any of the methods described above for use in the feature extraction operation. In some implementations, the identification of the object types can include the use of curve-fitting algorithms, for example, algorithms designed to fit a Gaussian curve or a polynomial curve (of order 2 or more) to each of some or all of the features. In some implementations, the touchscreen controller 802 can be configured to perform batch data processing at various intervals throughout the course of a life cycle of the display device 800 to better characterize what different objects looks like in order to facilitate the object identification operation.

In some implementations, the touch event detection operation performed in block 912 also includes registering touch events for those touch event candidates that are determined to be associated with intended contact (or intended input). In some implementations, the touch event detection module 812 determines whether touch event candidates are associated with intended input based on the object types (if any) identified for the touch event candidates, and in some implementations, also the amplitudes associated with the touch event candidates. For example, the touch event detection module 812 can register touch events for touch event candidates for which the identified object types are fingers or styluses. In contrast, the touch event detection module 812 can be configured to not register touch events for particular object types, for example, object types associated with objects that are generally not used in interacting with a touchscreen. In other words, while the touch event detection module 812 can identify object types for touch event candidates associated with objects that the touch event detection module 812 determines are in contact with the touchscreen, the touch event detection module can be programmed to not register touch events for particular objects. For example, the touch event detection module 812 may determine that a particular touch event candidate is caused by a palm or elbow and ignore such contact as unintended (incidental).

In some implementations, the touch event detection operation performed in block 912 also includes generating touch event data associated with the registered touch events. For example, the touch event data for a registered touch event can generally identify the coordinates associated with each registered touch event. For example, and as described above, the location associated with a touch event can be identified as the x- and y-coordinates associated with one of the nodes determined to be nearest a center of a centroid. In some other implementations, the location associated with a touch event can be identified as the coordinates associated with a pixel of the display determined to be nearest a center of a centroid. In some implementations, the touch event detection module 812 then passes the touch event data to the event handling module 816. The event handling module 816 generally creates a data structure for each registered touch event that includes the touch event data generated by the touch event detection module 812 including the location of the touch event.

In block 914, the touch event detection module 812 determines whether a touch event has been detected based on the results of the touch event detection operation in block 912. If the touch event detection module 812 determines that a touch event has not been detected for the given image frame, the process then returns to, for example, block 904 to perform the next scanning operation, at which point blocks 904-914 are repeated. In contrast, if in block 914 the touch event detection module 812 determines that a touch event has been detected, the process 900 proceeds to block 916 with performing an object effect isolation operation for each of the touch events. For example, in some implementations the force detection module 814 performs the object effect isolation operation.

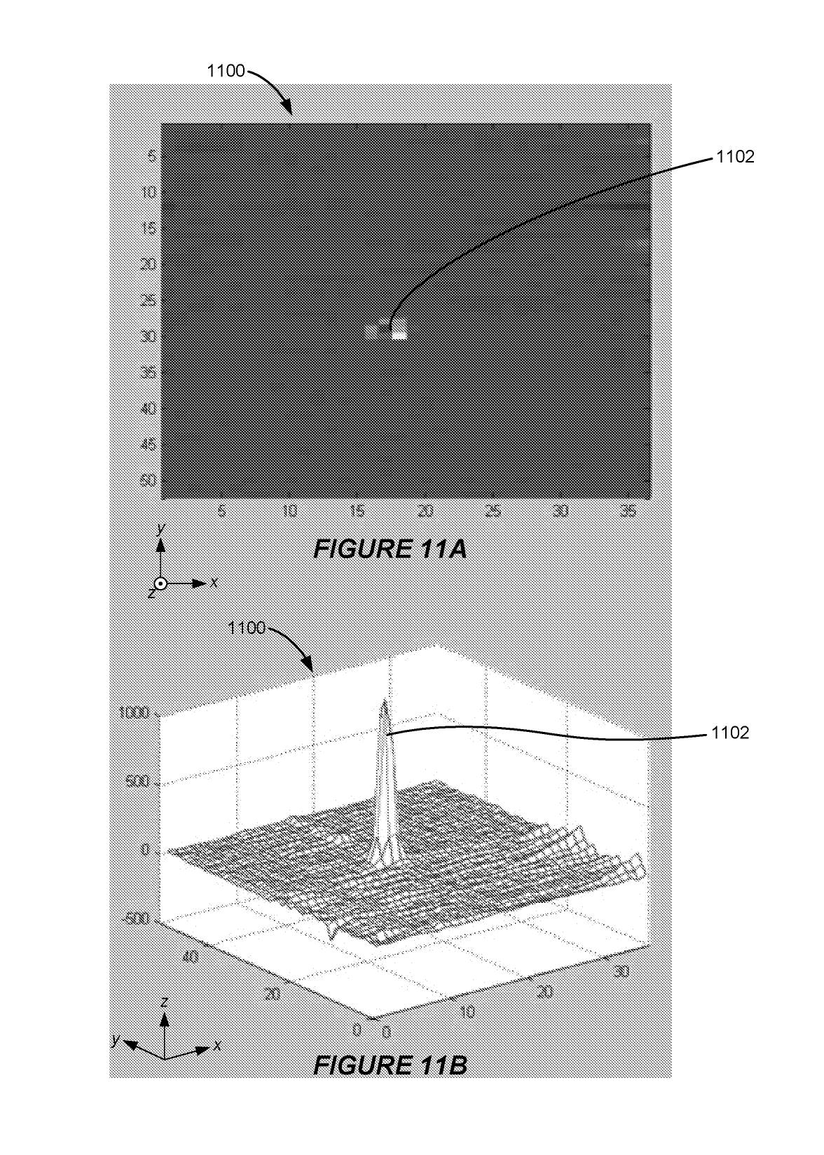

In some implementations, the object effect isolation operation performed in block 916 broadly includes analyzing the processed image frame and determining a contribution associated with the object effects (the “object effect component”). In other words, in some implementations, a goal of the object effect isolation operation is to isolate, identify, extract or otherwise estimate, for each touch event, the portion of the capacitance change associated with the touch event that is due to only the presence of the object on the touchscreen (the component not due to the deformation of the touchscreen). FIGS. 11A and 11B show two-dimensional and three-dimensional plots, respectively, of a portion of an example image frame 1100 illustrative of an isolation of the object effect contribution to the image frame 1000 of FIGS. 10A and 10B. As shown, the peak 1102 associated with the object effect component of the touch event is now isolated from the surrounding depression 1004 due to the deformation of the touchscreen that was present in the image frame 1000 of FIGS. 10A and 10B.

In some implementations, the force detection module 814 more specifically performs the object effect isolation operation on the touch event candidates generated by the feature extraction module 810 in block 910. In some implementations, the force detection module 814 more specifically performs the object effect isolation operation on only the identified touch event candidates for which touch events have been registered in block 912. In some implementations, the object effect isolation operation can include the use of curve-fitting algorithms, for example, algorithms designed to fit a Gaussian curve or a polynomial curve (of order 2 or more) to each of some or all of the touch event candidates. In some implementations in which curve-fitting or similar algorithms were performed by the feature extraction module 810 or the touch event detection module 812 when performing the feature extraction operation in block 910 or the touch event detection operation in block 912, respectively, the results (data) from such curve-fitting or similar algorithms can be passed to the force detection module 814 for use in determining the object effect component. And as described above, in some implementations, the touchscreen controller 802 can be configured to perform batch data processing at various intervals throughout the course of a life cycle of the display device 800 to better characterize what different objects looks like to facilitate the object effect isolation operation.

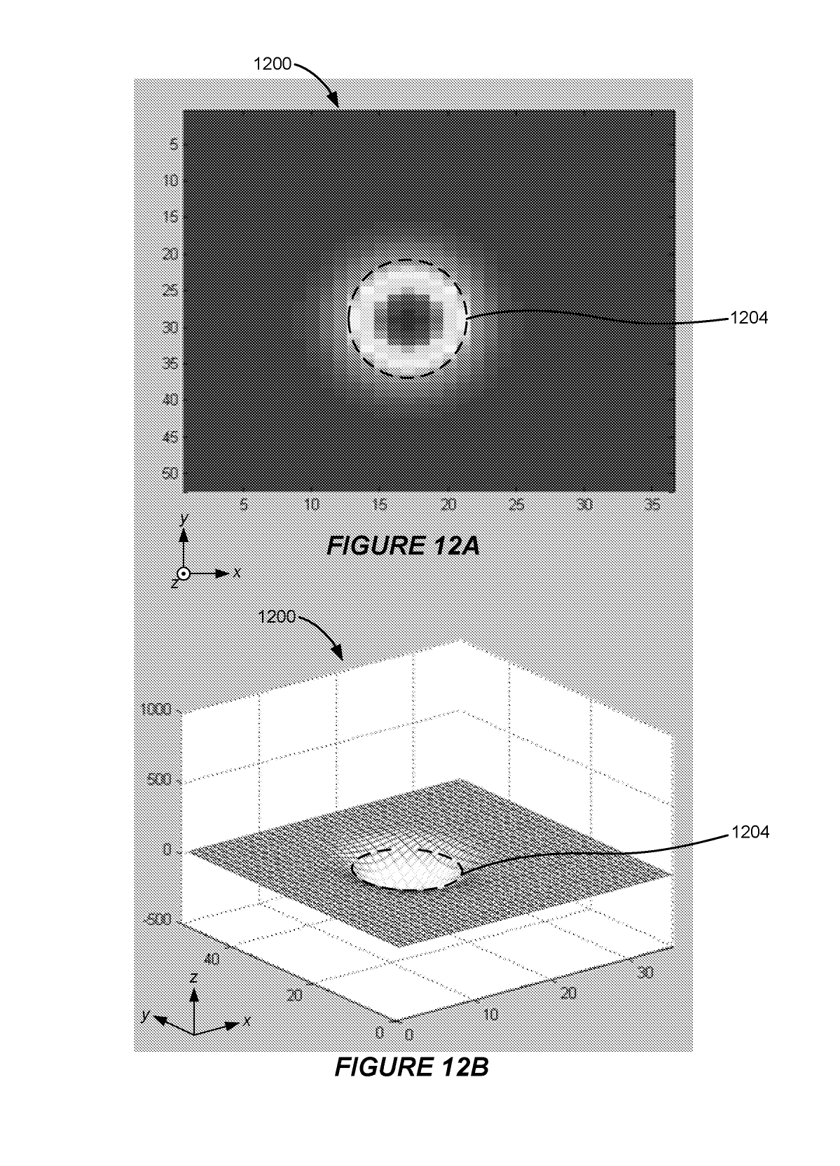

The process 900 proceeds to block 918 with performing a force effect isolation operation for each of the touch events. For example, in some implementations the force detection module 814 performs the force effect isolation operation. The force effect isolation operation broadly includes isolating, for each touch event, the portion of the processed image frame data resulting from only the force effects (the “force effect component”) as if there were no accompanying object effects. In other words, a goal of the force effect isolation operation is to determine the portion of the capacitance change associated with the touch event that is due to only the deformation of the touchscreen (the component not due to the presence of the object). FIGS. 12A and 12B show two-dimensional and three-dimensional plots, respectively, of a portion of an example image frame 1200 illustrative of an isolation of the force effect contribution to the image frame 1000 of FIGS. 10A and 10B. As shown, the depression 1204 associated with the force effect component of the touch event is now isolated from the peak 1002 associated with the object effect component that was present in the image frame 1000 of FIGS. 10A and 10B. In some implementations, to isolate the force effect component for each touch event, the force detection module is configured to subtract or otherwise separate or extract the object effect component (for example, such as that shown in FIGS. 11A and 11B) from the combined portion of the image frame (for example, such as that shown in FIGS. 10A and 10B).

The process 900 proceeds to block 920 with performing a force index determination operation for each of the touch events. For example, in some implementations the force detection module 814 performs the force index determination operation. The force index determination operation broadly includes quantifying, for each touch event, an amount of force applied (if any). In some implementations, the force detection module 814 is configured to analyze a maximum amplitude value associated with the force effect component (such as the depth of the depression 1204) to generate or otherwise determine the force index. In some implementations, the force detection module 814 is additionally or alternatively configured to analyze one or more of a size of an area associated with the force effect component (such as the width of the depression 1204) and a sharpness of the force effect (such as the slope of the depression 1204) to generate or otherwise determine the force index.

In some implementations, the force detection module 814 is configured to generate, in block 920, a digital value for the force index having a resolution limited only by a number of decimal places available to a digital variable (for example, an n-bit floating point variable). In some other implementations, the force detection module 814 is configured to, in block 920, select a value for the force index from a number of discrete possible values. It should also be appreciated by persons having ordinary skill in the art that the force detection module 814 may not generate force index values in units of force (or pressure). For example, the force detection module 814 can be configured to use a lookup table or algorithm that associates voltage amplitude with a corresponding force index. Generally, the granularity of the possible force index values can depend on the application using such force event data.

In some implementations, the force detection module 814 can be configured to determine a force index for a touch event in block 920 only if a force effect component amplitude (or other value characteristic of the force effect component) is above a threshold. For example, the force index determination operation can include a threshold detection operation during which the force detection module 814 compares the force effect amplitude to a threshold. In some such implementations, the force detection module 814 registers a force event in block 920 for the corresponding touch event only when the amplitude exceeds the threshold. In some such implementations, the force detection module 814 generates, selects or otherwise determines a force index for a touch event in block 920 only if a force event is registered. For example, such a threshold test can be used to determine whether a force was intended (consciously or subconsciously) by the user.

In some implementations, after a force index is determined in block 920, the process 900 proceeds to block 922 with performing a combination operation to combine the force event data, including the force index, with the touch event data. For example, in some implementations the event handling module 816 performs the combination operation. The combination operation performed in block 922 broadly includes, for each touch event, merging or otherwise combining the force event data with the touch event data in a touch event data structure. In other words, the combination operation can include combining the value of the force index associated with a touch event with the location coordinates associated with the touch event into a single touch event data structure. In some implementations, the event handling module 816 may have already generated the touch event data structure responsive to a positive touch event determination in block 912. In such implementations, the combination operation can include adding the force index value to the preexisting touch event data structure in block 922.

The process 900 then proceeds to block 924 with performing a communication operation to communicate the touch event data structure. For example, in some implementations the event handling module 816 performs the communication operation. The communication operation broadly includes, for each touch event, sending, transmitting or otherwise communicating the touch event data structure to the device system 804, for example, to the operating system 820. In some implementations, the touch event data structure can then be passed to an application 822 which can make use of both the fact that a touch event has occurred at a particular location as well as an amount of force applied at the particular location to perform, trigger or otherwise modify one or more operations, actions or states of the application 822 or other modules of the device system 804. In some implementations, the process 900 is repeated to perform a next scanning operation to generate a next image frame.

In some implementations, if a force event is not registered by the force detection module 814 in block 912, the force detection module 814 proceeds with alerting the event handling module 816 that a force event has not been detected. In some other implementations, the force detection module 814 can provide a force index of zero (0) to the event handling module 816. Generally, a touch event for which an accompanying force event is not registered, or for which a force index of zero is generated, can indicate that the corresponding touch was a light touch or that the object was not touching the touchscreen at all (for example, indicative of a hover). In some implementations, the touch events for which no force events are detected or for which the values of the force indices are zero can be ignored by applications executing in conjunction with the operation system 820 or even ignored by the operating system itself. For example, such touch events can be considered as false positives. In some other implementations, the operating system 820 and applications executing in conjunction with the operating system can be configured to accept touch events for which no force events are detected or for which the values of the force indices are zero (for example, representative of hovering objects).

It should also be noted that one or more of the modules or operations described above with reference to FIGS. 8 and 9 can act on or be applied to each frame in isolation or in the context of historical information collected or determined for one or more previous frames. Such historical information can facilitate the tracking of moving gestures or to aid in determining which touch event candidates represent actual intended contacts and which are merely manifestations of noise or false positives.

Various modifications to the implementations described in this disclosure may be readily apparent to those skilled in the art, and the generic principles defined herein may be applied to other implementations without departing from the spirit or scope of this disclosure. Thus, the following claims are not intended to be limited to the implementations shown herein, but are to be accorded the widest scope consistent with this disclosure, the principles and the novel features disclosed herein.

Additionally, certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. Moreover, various ones of the described and illustrated operations can itself include and collectively refer to a number of sub-operations. For example, each of the operations described above can itself involve the execution of a process or algorithm. Furthermore, various ones of the described and illustrated operations can be combined or performed in parallel in some implementations. Similarly, the separation of various system components in the implementations described above should not be understood as requiring such separation in all implementations. As such, other implementations are within the scope of the following claims. In some cases, the actions recited in the claims can be performed in a different order and still achieve desirable results.

What is claimed is:

1. A touch sensor system comprising:
a touchscreen including a plurality of electrodes;
a sense circuit operable to sense electrical signals from the plurality of electrodes;
an image processing module operable to generate an image frame based on the electrical signals sensed by the sense circuit;
a feature extraction module operable to analyze the image frame and to identify touch event candidates based on the analysis;
a touch event detection module operable to determine, for each identified touch event candidate, whether the touch event candidate is associated with a touch event; and
a force detection module operable to:
determine, for each touch event candidate associated with a touch event, a first component of the image frame associated with an object effect,
determine, for each touch event candidate associated with a touch event, a second component of the image frame associated with a force effect, and
determine a force index value associated with the force effect.

2. The touch sensor system of claim 1, the touch event detection module being operable to, for each identified touch event candidate, identify an object type associated with the touch event candidate and to determine whether the touch event candidate is associated with a touch event based on the object type.

3. The touch sensor system of claim 2, the touch event detection module being operable to identify the object type based on one or both of: a number of nodes contributing to the touch event candidate and a spatial distribution of the nodes contributing to the touch event candidate.

4. The touch sensor system of claim 2, the touch event detection module being operable to identify the object type based on a curve-fitting algorithm.

5. The touch sensor system of claim 1, the force detection module being operable to determine the first component of the image frame associated with the object effect based on one or more curve-fitting algorithms.

6. The touch sensor system of claim 1, the force detection module being operable to determine the second component of the image frame associated with the force effect by subtracting from the image frame the first component of the image frame associated with the object effect.

7. The touch sensor system of claim 1, the force detection module being operable to determine the force index value associated with the force effect based on one or both of an amplitude and a size associated with the force effect.

8. The touch sensor system of claim 1, further including an event handling module operable to generate a data structure including an identification of a location of the touch event and the force index value.

9. The touch sensor system of claim 8, the event handling module further operable to communicate the data structure to an application, the location of the touch event being a first input to the application, the force index value being a second input to the application.

10. The touch sensor system of claim 1, the touchscreen being configured as a capacitance-based touchscreen, the plurality of electrodes including a plurality of drive electrodes and a plurality of sense electrodes, the touch sensor system further including a drive circuit operable to generate and apply drive signals to the plurality of drive electrodes, the electrical signals sensed by the sense circuit being sensed from the plurality of sense electrodes.

11. The touch sensor system of claim 10, the touchscreen being configured as a mutual-capacitance-based touchscreen, the electrical signals sensed by the sense circuit being capacitively-coupled onto the plurality of sense electrodes from the plurality of drive electrodes.

12. A display device comprising:
the touch sensor system of claim 1; and
a display.

13. A system capable of determining a force index value associated with a touch event comprising:
touch-sensitive means;
means for sensing electrical signals from the touch-sensitive means;
means for generating an image frame based on the electrical signals sensed by the means for sensing;
means for analyzing the image frame and identifying touch event candidates based on the analysis;
means for determining, for each identified touch event candidate, whether the touch event candidate is associated with a touch event; and
force detection means for:
determining, for each touch event candidate associated with a touch event, a first component of the image frame associated with an object effect,
determining, for each touch event candidate associated with a touch event, a second component of the image frame associated with a force effect, and
determining a force index value associated with the force effect.

14. The system of claim 13, the means for determining, for each identified touch event candidate, whether the touch event candidate is associated with a touch event including means for identifying an object type associated with the touch event candidate, the determining of whether the touch event candidate is associated with a touch event being based on the object type.

15. The system of claim 14, the means for determining which of the touch event candidates are associated with touch events including means for identifying the object type based on one or both of: a number of nodes contributing to the touch event candidate and a spatial distribution of the nodes contributing to the touch event candidate.

16. The system of claim 14, the means for determining which of the touch event candidates are associated with touch events including means for identifying the object type based on a curve-fitting algorithm.

17. The system of claim 13, the force detection means including means for determining the first component of the image frame associated with the object effect based on one or more curve-fitting algorithms.

18. The system of claim 13, the force detection means including means for subtracting from the image frame the first component of the image frame associated with the object effect to determine the second component of the image frame associated with the force effect.

19. The system of claim 13, the force detection means including means for determining the force index value based on one or both of an amplitude and a size associated with the force effect.

20. The system of claim 13, further including:
means for generating a data structure including an identification of a location of the touch event and the force index value, and
means for communicating the data structure to an application, the location of the touch event being a first input to the application, the force index value being a second input to the application.

21. The system of claim 13, the touch-sensitive means including a plurality of drive electrodes and a plurality of sense electrodes, the system further including means for generating drive signals and means for applying the drive signals to the plurality of drive electrodes, the means for sensing electrical signals including means for sensing the electrical signals from the plurality of sense electrodes.

22. A method for determining a force index associated with a touch event comprising:
sensing electrical signals from a touchscreen;
generating an image frame based on the sensed electrical signals;
analyzing the image frame and identifying touch event candidates based on the analysis;
determining, for each identified touch event candidate, whether the touch event candidate is associated with a touch event;
determining, for each touch event candidate associated with a touch event, a first component of the image frame associated with an object effect;
determining, for each touch event candidate associated with a touch event, a second component of the image frame associated with a force effect; and
determining a force index value associated with the force effect.

23. The method of claim 22, the determining of whether the touch event candidate is associated with a touch event including identifying an object type associated with the touch event candidate, the determining of whether the touch event candidate is associated with a touch event being based on the object type.

24. The method of claim 23, the determining of which of the touch event candidates are associated with touch events including identifying the object type based on one or both of: a number of nodes contributing to the touch event candidate and a spatial distribution of the nodes contributing to the touch event candidate.

25. The method of claim 23, the determining of which of the touch event candidates are associated with touch events including identifying the object type based on a curve-fitting algorithm.

26. The method of claim 22, the determining of the first component of the image frame associated with the object effect being based on one or more curve-fitting algorithms.

27. The method of claim 22, the determining of the second component of the image frame associated with the force effect including subtracting from the image frame the first component of the image frame associated with the object effect.

28. The method of claim 22, the determining of the force index value associated with the force effect being based on one or both of an amplitude and a size associated with the force effect.

29. The method of claim 22, further including:
generating a data structure including an identification of a location of the touch event and the force index value, and
communicating the data structure to an application, the location of the touch event being a first input to the application, the force index value being a second input to the application.

30. The method of claim 22, the touchscreen including a plurality of drive electrodes and a plurality of sense electrodes, the method further including generating drive signals and applying the drive signals to the plurality of drive electrodes, the sensing of the electrical signals from the touchscreen including sensing the electrical signals from the plurality of sense electrodes.
